(19) United States
(12) Patent Application Publication
(10) Pub. No.: US 2009/0208706 A1
(43) Pub. Date: Aug. 20, 2009

(54) Blade Apparatus and Method of Manufacture Therefor

(76) Inventors: Hans Lindmark, Halmstad (SE); Juha Tiilikka, Halmstad (SE)

Correspondence Address: FROMMER LAWRENCE & HAUG, 745 FIFTH AVENUE- 10TH FL., NEW YORK, NY, 10151, US

(21) Appl. No.: 11/887,296

(22) PCT Filed: Mar. 31, 2005
(86) PCT No.: PCT/US05/10613

§ 371 Date: Feb. 25, 2009

(51) Int. Cl. B32B 3/02; B29C 43/00

(52) U.S. Cl. 428/172; 264/129

(57) ABSTRACT

An industrial blade for use in pulp and papermaking processes and method of making such a blade. The industrial blade is typically a doctor blade and is fabricated from a plurality of web layers, each web layer formed from a mixture of polyamide and copolyester, thereby forming a thick felt. A polyurethane coating is applied to an edge of the thick felt and the felt is cut at an angle on the coated edge.

### BACKGROUND

1. Field of the Invention

This invention relates generally to an industrial blade apparatus for use in papermaking and other manufacturing processes. More particularly, the present invention relates to a doctor blade fabricated from a thick felt having an angled edge coated with polyurethane.

2. Background Discussion

Pulp or papermaking machines utilize a variety of components during the pulp or papermaking process. These components include, for example, belts, presses and machine rolls. Machine rolls are used during various aspects of the pulp or papermaking process, for example, forming, pressing, drying and/or calendering operations.

The operation of machine rolls often requires a device to remove contaminants that form on the roll surface and/or to pull off the sheet from the machine rolls. Failure to effectively remove contaminants or the sheet from a machine roll can have catastrophic effects on the quality of the product being produced. One way of achieving this is through the use of a mechanical device commonly referred to as a doctor or doctor blade.

Also, during operation of papermaking machines, and particularly during operation of presses, such as in press sections with long nip presses and especially with grooved belts, there is a high risk of inefficient dewatering as the belt surface and grooves may have a film layer of water present as the belt returns to the press nip. Accordingly, a doctor blade may be instrumental in removing excess water from the belt.

Doctor blades can be of rigid or flexible design depending upon the desired application. Also, doctor blades are typically removable and therefore replaceable when worn out.

The doctor blade is typically fastened to a structural beam that is adjustably supported across the papermaking machine on which a blade holder and a blade is provided. The doctor blade comes in direct contact with the roll surface to scrape off any contaminants from the roll surface including the whole pulp or paper web sheet or parts thereof.

For example, European Patent Application EP 1 295 988 by Takeuchi et al., entitled, “Doctor Blade” relates to a doctor blade fabricated from an integrated base material and batt fiber layers. Resin is impregnated into one side of the fibrous laminate. In use, the layer in which the amount of resin is small is in contact with a belt. This application is hereby incorporated by reference in its entirety herein.

Also, European Patent Application EP 1 298 250 by Takeuchi et al., entitled, “Doctor Blade” relates to a doctor blade with a resin impregnated into a fibrous laminate that includes base materials and batt layers integrated by needle punching. This application is hereby incorporated by reference in its entirety herein.

Thirdly, European Patent Application EP 1 342 842 by Takeuchi et al., entitled, “Doctor Blade for Removing Water” relates to a laminated, resin-impregnated doctor blade for removing water from a grooved belt. Fibers of the belt-contacting layer are oriented in the direction of travel of the belt. This application is hereby incorporated by reference in its entirety herein.

Unfortunately, using a doctor blade of the type above for removing water and other contaminants, undesirably wears, or abrades, the grooved belt surface. This wear is typically due to polyester, also referred to as PET herein or glass fibers in the doctor blade, which, when impregnated with a hard resin, cause a hard grinding surface to be in contact with the softer belt surface, usually made of polyurethane resin, also referred to as PUR herein.

A second source of surface wear of the grooved belt is contaminants or foreign particles such as calcium carbonate (CaCO₃) that become trapped or lodged in damaged areas on a doctor blade caused by pitting or bending of the blade. This further exacerbates the grinding on the belts, thereby reducing operational life of the belt.

Furthermore, the use of transfer belts increases the need for an improved doctor blade over the type described above. The surface of a transfer belt is softer and more compliable than a shoe press belt. Since a transfer belt is in direct contact with a paper web, its surface can pick up contaminants/stickies from the web that must be removed. Prior to entering a press nip, a transfer belt's surface must be relatively dry in order to minimize loss in dewatering efficiency as well as minimize the thickness of the water film created on the belt surface so as to prevent incipient crushing of the paper web and/or to allow the water film to break up resulting in the paper sheet being released from the transfer belt. Additionally, the transfer belt's surface cannot be unevenly worn or scored/scratched by a contaminant embedded in the edge of a doctor blade. An unevenly worn transfer belt will cause nonuniform pressure to be applied to the paper web that can affect both sheet dewatering and sheet transfer. A scored/scratched belt will result in a mark on the paper sheet.

Therefore, it would be an advancement in the art to have a doctor blade with a surface that minimizes wear and abrasion of a surface, which may be a belt or otherwise that the blade contacts, while still satisfactorily performing the blade's intended function.

### SUMMARY OF THE INVENTION

The present invention is directed toward an industrial blade, such as a doctor blade, having a surface that minimizes the wear of a surface of a component that the blade contacts, thereby increasing the operational life of the component.

Accordingly, one embodiment of the present invention relates to an industrial blade that includes a plurality of web layers, with each web layer formed from a mixture of polyamide and copolyester. An edge of the web layers also has a polyurethane coating and the blade is fabricated to have an angled portion.

Another embodiment of the present invention relates to a method of manufacturing a blade. The method includes providing a plurality of web layers, each web layer formed from a mixture of polyamide and copolyester. The plurality of web layers is needled to form a thick felt, which is then calendered. Polyurethane is applied to an edge of the thick felt, and an angled surface is formed on the edge after a predetermined period of time.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated in the accompanying drawings in which corresponding components are identified by the same reference numerals.

### BRIEF DESCRIPTION OF THE DRAWINGS

Thus by the present invention, its objects and advantages will be realized, the description of which should be taken in conjunction with the drawings wherein:

FIG. 1 shows a perspective view of a blade, according to the present invention, that may be used in papermaking and pulp making machines;

FIG. 2 illustrates web layers for fabricating the blade;

FIG. 3 illustrates a needling process for the web layers;

FIG. 4 illustrates a hot calendering process of a thick felt;

FIG. 5 illustrates a polyurethane treatment of a region of the thick felt;

FIG. 6 illustrates the edge region being cut at an angle;

FIG. 7 shows an example of dimensions of a blade according to the present invention;

FIG. 8 shows an example of an installed blade of the present invention; and

FIG. 9 shows a comparison of abrasion test results for a belt using a conventional blade and using a blade according to the present invention.

### DETAILED DESCRIPTION OF THE PREFERRED EMBODIMENTS

The present invention provides an improved doctor blade and a method of manufacturing such a blade. In one embodiment, the present invention addresses the issue of belt wear resulting from a surface of the doctor blade in contact with a softer belt such as one made from polyurethane (PUR). Secondly, the present invention also addresses the issue of contaminants or foreign particles, that become trapped or lodged in a damaged edge of a conventional doctor blade. Such damage can occur from pitting or bending of the blade. Trapped contaminants or foreign particles will not only cause wear of the belt but may result in scoring/scratching of the belt surface ultimately resulting in sheet marking.

### I. Reduction of Belt Wear Due to Doctor Blade Friction

Specifically, the present invention provides an improved doctor blade by eliminating PET fibers or glass fibers from the blade and constructing a doctor blade from a fiber mixture of polyamide (PA) and copolyester. This mixture provides a softer and less abrasive surface that contacts the surface being doctored, such as a belt or roll cover. The fibers are mixed and needled to form a thick felt, which is then cut in long strips.

The strips are then hot pressed or calendered at a sufficiently high temperature (e.g. 200° C. or more) to achieve the required hardness and stiffness characteristics necessary for a desired application, such as papermaking or other manufacturing process that utilize doctor blades.

Following the hot pressing step, one or more edges of the thick felt is cut at a desired angle, for example an angle between approximately 25 degrees and 80 degrees from a longitudinal axis of the thick felt, and preferably approximately 45 degrees.

Once the edge of the blade has been formed by the cutting operation, the blade may be mounted in a fixed or flexible manner such as in a doctor mounting or doctor back so that the doctor blade interacts in a desired manner with the surface being doctored, for example a belt or roll cover.

### II. Particles Filling Interstitial Regions of Doctor Blade

Another embodiment of the present invention, which may be used in conjunction with the embodiment described above, is that the blade, particularly the blade edge in contact with a belt or roll cover, is resistant to penetration by undesired contaminants or foreign particles. This resistant characteristic is accomplished by treating a region of the blade, typically a region that includes the portion cut at an angle, with polyurethane. Thus, the treatment process seals the blade edge and reduces introduction of foreign particles or contaminants into surfaces of the blade, decreasing the potential of the blade from scoring/scratching a belt surface, ultimately reducing sheet marking. Further, only a desired portion of the angled blade may be treated with polyurethane. In order to achieve a doctor that is more flexible over the prior art as well as one that is resistant to contaminants, only the upper portion of the blade or the portion of the blade in contact with or interacting with the surface being doctored is treated with polyurethane.

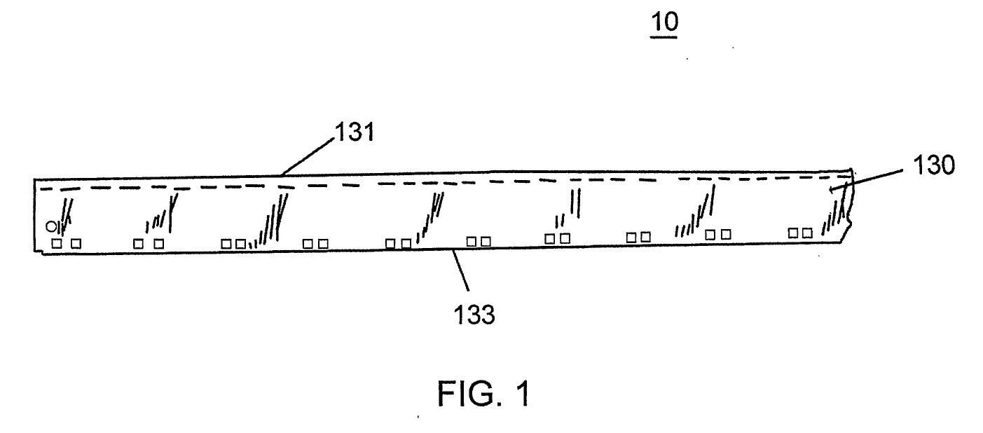

FIG. 1 shows a perspective view of a blade 10, fabricated according to the present invention that may be used in papermaking and pulpmaking machines. Blade 10 has a body portion 132. The blade has an upper surface 131, which typically contacts a belt or other surface for doctoring purposes, for example, to remove water, and a lower portion 133, which is typically used to secure the blade 10 to a mounting apparatus or guide arm or other support structure (not shown).

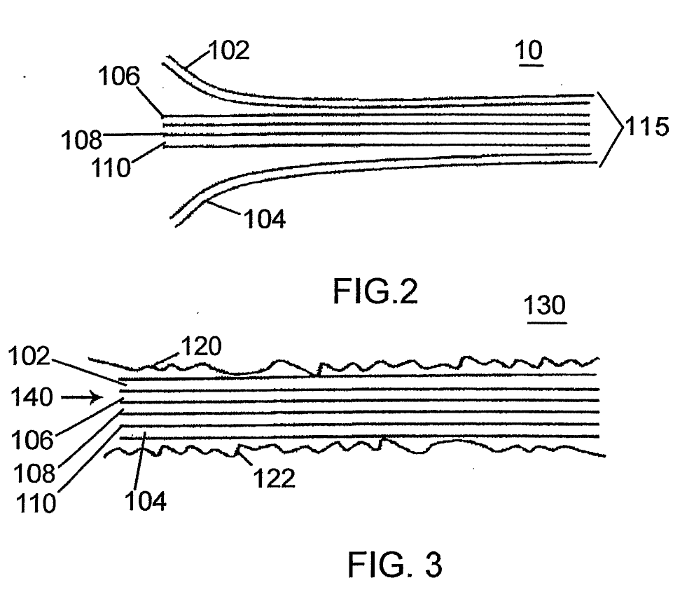

FIG. 2 illustrates web layers 115 for fabricating the blade body 10 according to the present invention. The blade 10 is fabricated from a plurality of web layers 102, 104, 106, 108 and 110. As shown in FIG. 2, web layers 106, 108 and 110 are already assembled with web layers 102 and 104 being applied to the upper and lower surfaces, respectively.

FIG. 3 illustrates a needling process to form a thick felt 130. Web layers 102, 104, 106, 108 and 110 are assembled to form a stack of web layers, 140. The stack 140 is needled with material 120 and 122 on the upper and lower surfaces, respectively, to form a thick felt 130. (For example 122 is in contact with web layer 104 and 120 is in contact with web layer 102.)

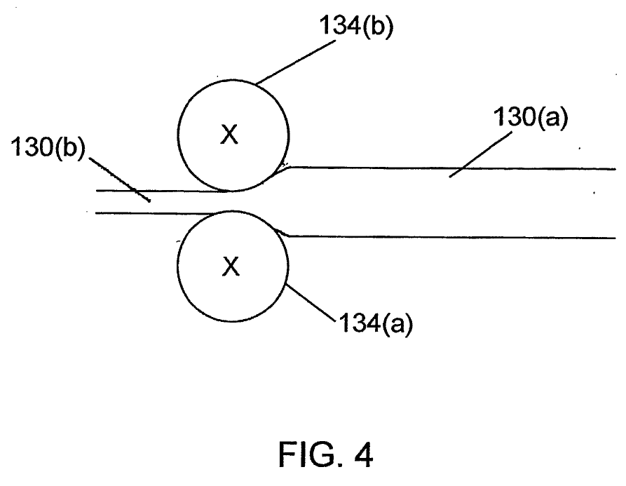

FIG. 4 illustrates a hot calendering process of the thick felt 130. The thick felt 130 (from FIG. 3) is calendered using rollers 134(a) and 134(b). As shown in FIG. 4, portion 130(a) represents the thick felt prior to a calendering operation and portion 130(b) represents the thick felt after a calendering operation.

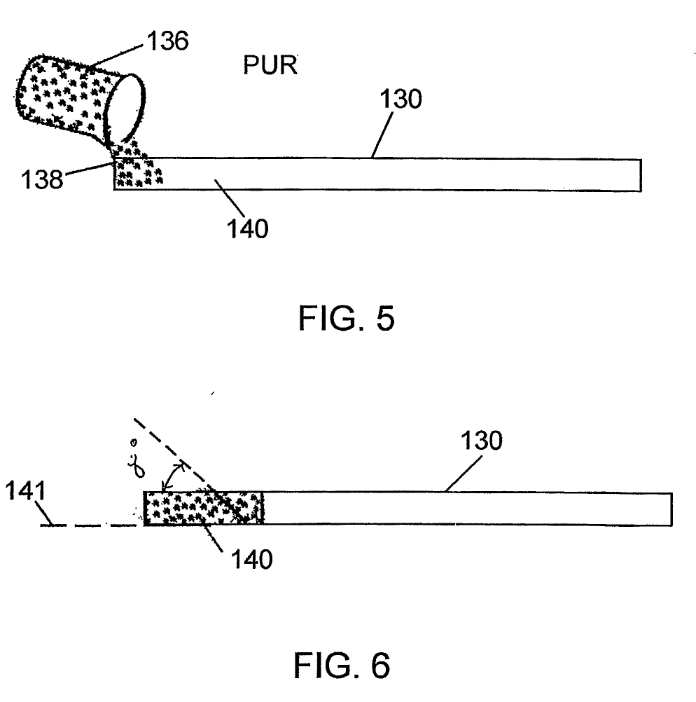

FIG. 5 illustrates a polyurethane treatment of an edge region of the thick felt 130. A portion 140 of the thick felt 130, which has been calendered, as shown in FIG. 4, above, is coated, or treated, with a material 136 such as polyurethane or other material suitable for the purpose. The coating or treatment process is typically accomplished by soaking the portion 140 with the treatment compound. As shown in FIG. 5, the treatment material 136 is absorbed or adhered, as shown by element 138, to portion 140.

FIG. 6 illustrates the edge region 140 being cut at an angle. As shown in FIG. 6, thick felt 130 with treated portion 140 is cut an angle α, which is typically between approximately 25 and 80 degrees relative to an axis 141 of member 130. Preferably, the angle α is between approximately 35 and 55 degrees relative to axis 141 of member 130 and most preferably the angle α is approximately 45 degrees relative to axis 141 of member 130. Cutting the treated edge of the thick felt 130 results in blade 10.

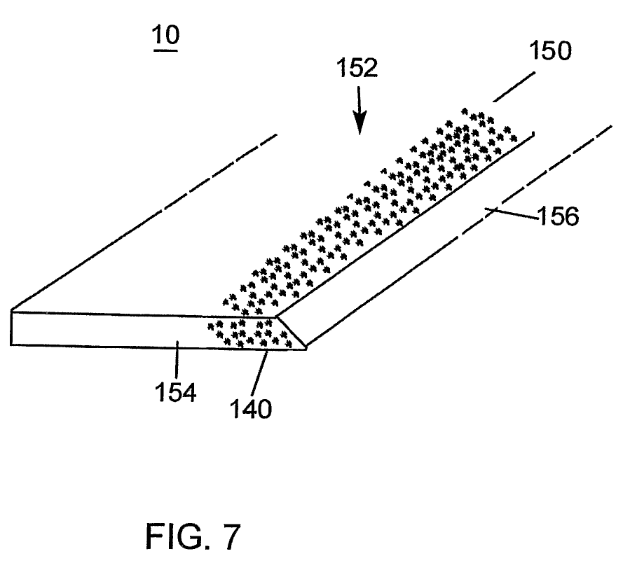

FIG. 7 shows an example of dimensions of a blade 10 according to the present invention. The blade 10 has upper lateral surface 152, which includes treated region 150; first edge portion 154 with treated region 140 and second edge portion 156. The blade may have dimensions, such as, for example, the length of portion 154 being between approximately 10 centimeters and 20 centimeters; the height of portion 154 between approximately 0.25 centimeters and 3 centimeters; and the length of edge 156 between approximately 2 and 12 meters. Blade stock can be produced at any length and cut down into a plurality of blades of desired lengths.

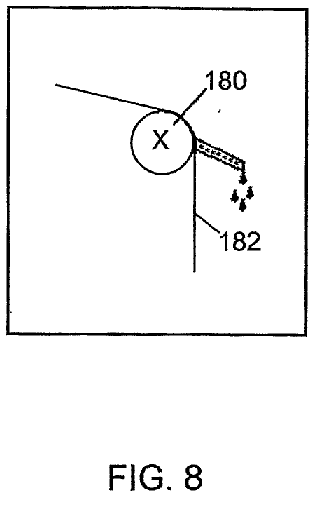

FIG. 8 shows an example of an installed blade 10 of the present invention. The doctor blade 10 is disposed relative to a belt 182 that is in contact with roller 180. The doctor blade 10 has an angle surface, as described herein, that is in contact with the belt 182 to remove water and/or other material from belt 182.

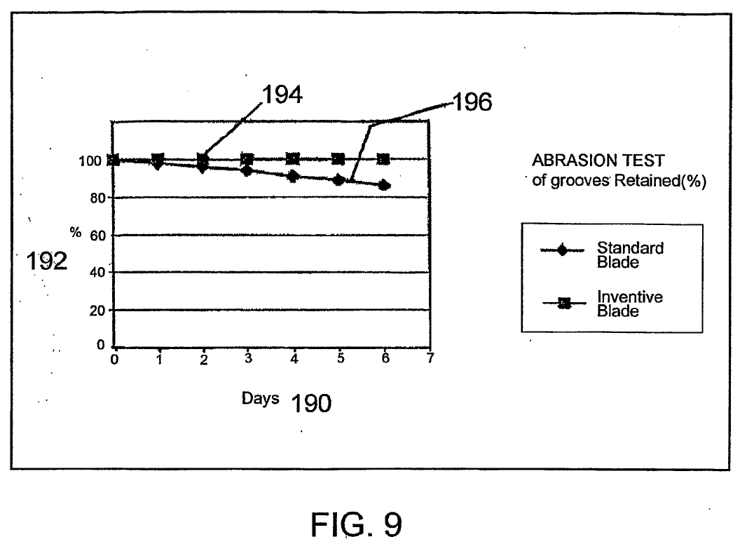

FIG. 9 shows a graph 90 of abrasion test results for a general shoe press belt used with a conventional blade and a blade according to the present invention. Specifically, graph 90 has horizontal axis 190, which represents days of operation and vertical axis 192, which represents percent of belt grooves present. As shown by line 196, the standard blade caused increased deterioration or surface degradation of the belt, particularly after two days of use. Line 194 shows that a blade fabricated according to the present invention has improved wear characteristics on the belt and does not degrade the belt as quickly as the other blade (line 196).

Thus, while fundamental novel features of the invention shown and described and pointed out, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in another form or embodiment. It is the intention, therefore, to be limited only as indicated by the scope of the claims appended hereto.

What is claimed is:

1. A method of manufacturing a blade comprising:
providing a plurality of web layers, each web layer formed from a mixture of polyamide and copolyester;
needling the plurality of web layers to form a thick felt;
calendering the thick felt;
applying polyurethane to a desired portion of an edge of the thick felt; and
forming an angled surface on the edge.

2. The method as claimed in claim 1, wherein the angled surface is formed at an angle between approximately 25 and 80 degrees.

3. The method as claimed in claim 1, wherein the angled surface is formed at approximately 45 degrees.

4. The method as claimed in claim 1, wherein the calendering step is performed at an elevated temperature.

5. The method as claimed in claim 1, wherein the desired portion is an upper surface of the blade interacting with a surface being doctored.

6. An industrial blade comprising:
a plurality of web layers, each web layer formed from a mixture of polyamide and copolyester;
a polyurethane coating on a desired portion of an edge of the plurality of web layers; and
an angled surface of the coated region.

7. The industrial blade as claimed in claim 6 wherein the angled surface is formed at an angle between approximately 25 and 80 degrees.

8. The industrial blade as claimed in claim 7, wherein the angled surface is approximately 45 degrees.

9. The industrial blade as claimed in claim 6, wherein the web layers are calendered during a fabrication process.

10. The industrial blade as claimed in claim 9, wherein the web layers are calendered at an elevated temperature.

11. The industrial blade as claimed in claim 6, wherein the desired portion is an upper surface of the blade interacting with a surface being doctored.
